(19) United States
(12) Patent Application Publication
(10) Pub. No.: US 2007/0196580 A1
(43) Pub. Date: Aug. 23, 2007

(54) Water resistant hydrophilic coatings

(76) Inventors: Damodar R. Patil, Palos Hills, IL (US); George F. Fanta, Morton, IL (US); Frederick C. Felker, Morton, IL (US)

Correspondence Address: CONLEY ROSE, P.C., 5700 GRANITE PARKWAY, SUITE 330, PLANO, TX, 75024, US

(21) Appl. No.: 11/358,458

(22) Filed: Feb. 22, 2006

(51) Int. Cl. B05D 3/02; C08L 9/00

(52) U.S. Cl. 427/384; 524/78

(57) ABSTRACT

A water-resistant hydrophilic coating comprising a hydrophilic base material, a lipid, an adhesion promoter, a surfactant and a crosslinking agent. A method of preparing a water-resistant polymer surface comprising preparing an adhesive coating comprising a hydrophilic base material, a lipid, an adhesion promoter, a surfactant and a crosslinking agent, applying said adhesive coating to a polymer surface, and heat treating said polymer surface under conditions sufficient to allow cross linking of the adhesive coating. A method of increasing the absorption of water-based or oil-based dyes, inks, or fragrances in a hydrophilic coating comprising incorporating a lipid into the hydrophilic coating.

### CROSS-REFERENCE TO RELATED APPLICATIONS

This application is related to commonly owned U.S. patent application Ser. Nos. 11/138,737, filed on May 26, 2005 and entitled “Polysaccharide Based Hydrophilic Coatings,” and 11/202,794, filed Aug. 12, 2005 and entitled “Water Resistant Hydrophilic Coatings,” which are incorporated by reference herein.

### STATEMENT REGARDING FEDERALLY SPONSORED RESEARCH OR DEVELOPMENT

Not applicable.

### BACKGROUND OF THE INVENTION

1. Field of the Invention

This invention relates generally to adhesive coatings. More specifically, this invention relates to hydrophilic adhesive coatings for hydrophobic substrates.

2. Background of the Invention

Articles constructed from synthetic polymeric materials such as polyethylene (PE) and polypropylene (PP) have found widespread use in our daily lives. While such polymeric materials have desirable bulk mechanical properties they often exhibit undesirable surface properties. This may limit their utility since the surface properties of polymeric materials are often a major determinant in their usage. Thus, despite their widespread applications, a need exists to remedy certain limitations associated with the usage of synthetic polymeric materials. One method of increasing the adaptability of these polymeric materials to new uses has been to modify their surface properties. In particular, modifications of the surface of hydrophobic polymeric materials are often required to extend their utility.

One approach to surface modification involves altering the hydrophobicity of the polymeric surface by applying a coating having the desired properties. Introduction of a hydrophilic coating to the hydrophobic surface of a polymer material may render these materials suitable for applications that require improved biocompatibility, improved compatibility with hydrophilic reagents, reduced build-up of electrostatic charge, reduced friction and improved absorption of both water-based and oil-based compounds such as dyes, inks and fragrances. This latter criterion, the absorption of both water and oil-based compounds may require the use of a composite material capable of stabilizing both polar (e.g., water-based) and nonpolar (e.g., oil-based) compounds.

Thus a need exists for a hydrophilic coating for hydrophobic substrates that is able to absorb both water-based and oil-based compounds.

### BRIEF SUMMARY OF SOME OF THE PREFERRED EMBODIMENTS

Disclosed herein is a water-resistant hydrophilic coating comprising a hydrophilic base material, a lipid, an adhesion promoter, a surfactant and a crosslinking agent.

Also disclosed herein is a method of preparing a water-resistant polymer surface comprising preparing an adhesive coating comprising a hydrophilic base material, a lipid, an adhesion promoter, a surfactant and a crosslinking agent, applying said adhesive coating to a polymer surface, and heat treating said polymer surface under conditions sufficient to allow cross linking of the adhesive coating.

Further disclosed herein is a method of increasing the absorption of water-based or oil-based dyes, inks, or fragrances in a hydrophilic coating comprising incorporating a lipid into the hydrophilic coating.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### DETAILED DESCRIPTION OF THE PREFERRED EMBODIMENTS

Disclosed herein are hydrophilic coating compositions and methods of preparing same. In an embodiment, the hydrophilic coating composition comprises a hydrophilic base material and a lipid, alternatively a hydrophilic base material, a lipid, an adhesion promoter and/or a surfactant, alternatively, a hydrophilic base material, a lipid, an adhesion promoter, a surfactant and a crosslinking agent, alternatively a hydrophilic base material, a lipid, an adhesion promoter, a surfactant, a crosslinking agent and a crosslinking agent accelerator. Hydrophilic coatings comprising at least one hydrophilic base material and a lipid are referred to hereafter as lipid modified coatings (LMC). Such LMCs may be prepared as will be described in detail later herein and used to coat a suitable substrate. Substrates coated with the LMC may display desirable properties such as having improved biocompatibility, improved compatibility with hydrophilic reagents, reduced build-up of electrostatic charge, reduced friction and improved absorption of both water-based and oil-based dyes, inks and fragrances.

In an embodiment the LMC comprises a hydrophilic base material. The hydrophilic base material may be a water-soluble polymer. Without limitation, examples of water-soluble polymers include natural gums such as karaya, tragacanth, ghatti and guar gum; polyvinyl alcohol; polyvinyl pyrrolidone; modified celluloses such as carboxymethyl, hydroxyethyl or hydroxypropyl cellulose; polyacrylic acid; polyethylenimine; or combinations thereof. Alternatively, the water-soluble polymer is a starch, modified starch or starch mixture.

In an embodiment, the starch may be a non-gelling starch, a waxy starch, an amylose-containing starch or combinations thereof. As used herein, a non-gelling starch is one that when placed in solution does not form a viscous semi-rigid structure upon absorption of water and heating or during the cooling of said solution. In an embodiment, the waxy starch is waxy cornstarch consisting essentially of amylopectin. As used herein a waxy starch is one that contains less than about 10% weight/weight (w/w) amylose. As used herein an amylose-containing starch is one having equal to or greater than about 10% amylose. In an embodiment, the amylose content of the starch is less than about 13%, alternatively less than about 12%. Without wishing to be limited by theory, the reduced amylose content in the LMC may prevent retrogradation and gel formation thereof.

In some embodiments, the starch is a gelling starch wherein gel formation can be reversed or inhibited. For example, the starch may be an amylose-containing starch containing greater than or equal to about 25% amylose. Starch containing greater than or equal to about 25% amylose when dissolved in water and heated forms a gel when the solution is allowed to cool at room temperature. However, agitating the cooled solution, for example by stirring or shaking, may reverse the gel formation. Alternatively, gel formation in a 25% amylose containing starch solution may be inhibited by rapidly cooling the solution. Methods of rapidly cooling a solution are known to one skilled in the art and include for example transfer of the hot solution to an ice bath.

Starches suitable for use in the LMC include without limitation those isolated from cereal crops such as rice and corn or tuber crops such as cassaya and potato. Without limitation, examples of suitable starches include Starch from Rice (S7260) and/or Starch from Corn (S9679) both available from Sigma, Aldrich and Pure Food Grade starch and/or 7350 Waxy starch #1 both available from A. E. Staley. In an embodiment, the LMC comprises from about 2% w/v to about 8% w/v starch, alternatively from about 3% w/v to about 6% w/v starch, alternatively from about 4% w/v to about 6% w/v starch. The w/v is defined as the number of grams of a component in a solution divided by the total volume in milliliters of the solution multiplied by 100%. Herein, the term aqueous solution also refers to aqueous dispersions, in which solid materials are intimately dispersed in water so that they do not readily settle or otherwise separate from the aqueous phase.

In an embodiment, aqueous solutions of each reagent in the LMC are prepared by dissolving/dispersing the reagent in a suitable volume of water. The concentration of the reagents at this point is termed the initial % w/v. The initial % w/v is calculated by dividing the grams of reagent used by the volume in milliliters of solution (e.g., water) added to produce the aqueous solution. In an embodiment, these aqueous solutions of reagents are used to prepare the LMC. For convenience, the LMC formulations are based on 100 grams of LMC, with a resultant calculation of the grams of aqueous reagent required to prepare the 100 grams of LMC. Upon addition of each of the reagents to the LMC, the concentration of the reagent is diluted from the initial % w/v to a final % w/v. The final % w/v of each reagent in the LMC is determined by multiplying the initial % w/v of each component by the number of grams of component used in preparing the 100 grams of the LMC. The sum of the % w/v contribution of each component in the LMC is referred to herein as the total solids content. Hereafter, the numerical values given with percentages refer to the final % w/v unless noted otherwise.

In an embodiment, the starch is provided as an aqueous starch solution/dispersion. This aqueous starch solution may contain a sufficient amount of starch and water to produce an LMC with a viscosity suitable for ease of pouring and/or sprayability. In an embodiment, the starch solution/dispersion may comprise an initial % w/v of from about 10% to about 20% starch in aqueous solution/dispersion having a pH of from about 3.5 to about 7, alternatively about 7.

In some embodiments, the water-soluble polymer may be substituted with a water-dispersible or water-reducible polymer to provide a final formulation that is less hydrophilic in nature than the LMC formed with a water-soluble polymer. Examples of water-dispersible and water-reducible polymers are known to one skilled in the art. LMCs formed using water-dispersible or water-reducible polymers as the hydrophilic base material may result in coatings that are less hydrophilic than those formulated using water-soluble polymers as the hydrophilic base material. However, when compared with the uncoated surface of a suitable hydrophobic polymeric substrate, the LMCs prepared with water-reducible or water-dispersible polymers may be more hydrophilic than the uncoated substrate surface. Thus, application of an LMC having a water-dispersible polymer or water-reducible polymer as the hydrophilic base material may provide a coating that enhances desirable surface properties of the substrate to which it is applied. However, for simplicity herein the term LMC refers collectively to coatings prepared with water-dispersible, water-reducible or water-soluble polymers.

In an embodiment, the LMC contains a lipid. Herein the term lipid (or fat) is a comprehensive term referring to substances which are found in living cells and which are comprised of only a nonpolar hydrocarbon moiety or a hydrocarbon moiety with polar functional groups as described in the Encyclopedia of Chemistry, 3rd Edition, C. A. Hampel and G. G. Hawley, eds., 1973, p. 632 which is incorporated by reference herein. Lipids may be divided into subcategories such as fats and oils. Fats constitute a major division of the lipid family. Fats are given their common definition as glycerol esters of fatty acids, which are chiefly palmitic, stearic, oleic and linoleic; although many other fatty acids are found in nature. Hackh's Chemical Dictionary, 4th Edition, G. Grant, ed., 1969, p. 470, d

In an embodiment, any lipid capable of producing the desired LMC properties and compatible with the other components of the LMC may be employed. Examples of lipids suitable for use in the LMC include without limitation soybean oil, soy fatty acid, tallow fatty acid, paraffin oil, wax with a melting point of less than about 60° C. and combinations thereof. Such lipids are well known to one of ordinary skill in the art and are widely commercially available. In an embodiment, the lipid is present in amounts of from about 100 parts hydrophilic base material (eg starch): 5 parts lipid; alternatively, from about 100 parts hydrophilic base material (eg starch): 10 parts lipid; alternatively, from about 100 parts hydrophilic base material: 20 parts lipid.

In an embodiment, the LMC contains an adhesion promoter. Without wishing to be limited by theory, the adhesion promoter may serve to increase the compatibility between the LMC and the hydrophobic substrate through the reduction of interfacial tension. Interfacial tension is defined as the surface free energy that exists between two immiscible liquid phases, such as oil and water. In an embodiment, the adhesion promoter is any material chemically compatible with the LMC that serves to increase the adherence of the LMC to the hydrophobic substrate by reducing the interfacial tension. In an embodiment, the adhesion promoter is an epoxy resin present in amounts of from about 0.5% to about 2.0% of the LMC.

Without limitation, examples of suitable adhesion promoters include EPI-REZ Resin 3510-W-60 available from Resolution Performance Products and Epoxy 6128W65 from Pacific Epoxy Polymers. In an embodiment, an adhesion promoter for use in the LMC (e.g., EPI-REZ Resin 3510-W-60) has about the physical properties given in Table I.

TABLE I

| Physical Property | Value |
|---|---|
| Viscosity at 25° C. | 500-5000 |
| (Brookfield RVT, #5 spindle at 10 rpm) | |
| Nonvolatiles, percent | 60-62 |
| Solvent | Water |
| Pounds/gallon | 9.0 |
| Particle size, Coulter (vol. mean), microns | 1.0-2.2 |
| pH | 2-5 |
| Weight per epoxide, on solids | 185-215 |

In an embodiment, the LMC contains a surfactant. Without wishing to be limited by theory, a surfactant in the LMC may serve to modify physical properties thereof such as the surface tension, emulsification or cloud point. The surface tension is defined as the free energy between a liquid and air. In an embodiment, the surfactant is any material chemically compatible with the LMC that is capable of reducing the surface tension of the LMC while increasing adhesion of the LMC to the substrate. In an embodiment, the surfactant is a fluorosurfactant. In an alternative embodiment, the surfactant is sodium lauryl sulfate. In an embodiment the LMC comprises from about 0.05% to about 0.5% of surfactant, alternatively from about 0.1% to 0.3% of surfactant, alternatively about 0.25% surfactant. Without limitation, examples of suitable surfactants include ZONYL FSA and ZONYL FSP available from Dupont and sodium lauryl sulfate available from Sigma-Aldrich. In an embodiment, a surfactant for use in the LMC (e.g., ZONYL FSP) has about the physical properties given in Table II.

TABLE II

| Property | Value |
|---|---|
| Structure | (R_{f}CH₂CH₂O)xP(O)(ONH₄)y |
| | where R_{f} = F(CF₂CF₂)z |
| | x = 1 or 2 |
| | y = 2 or 1 |
| | x + y = 3 |
| | z = 1 to about 7 |
| Solubility | [symbol] 2% in water and methyl alcohol |
| | 0.7% in isopropyl alcohol |
| | 0.1% in acetone |
| | insoluble in ethyl acetate, TLMC, n- |
| | heptane, methyl chloroform and |
| | toluene |
| Specific gravity @ | 1.15 |
| 25° C. | |
| Density @ | 9.6 |
| 25° C. (lb/gal) | |
| Surface tension in | 24 @ 0.01% |
| deionized water @ | active ingredient |
| 25° C. (dyn/cm) | |

In an embodiment, the LMC contains a crosslinking agent. Without wishing to be limited by theory, a crosslinking agent in the LMC may serve to render the LMC water-resistant through a reaction of the starch hydroxyl groups with a functionality of the crosslinking agent. Such reactions would make the starch hydroxyl groups unable to hydrogen bond with water thus resulting in a water-resistant coating. The addition of a crosslinking agent to the LMC may also increase the resistance of the starch to swelling. In an embodiment, the crosslinking agent is a melamine resin, alternatively a methylated melamine resin, alternatively a methylated melamine formaldehyde resin, alternatively a methylated high imino melamine resin, alternatively a derivative of hexamethoxymethylmelamine (HMMM) or combinations thereof. In an embodiment, the LMC comprises from about 0.5% to about 4% cross-linking agent, alternatively from about 1% to about 3% cross-linking agent, alternatively about 2% cross-linking agent. Without limitation, a representative example of a suitable crosslinking agent is a methylated high imino melamine resin sold as CYMEL 323 by Cytec Industries Inc. In an embodiment, a crosslinking agent for use in the LMC (e.g., CYMEL 323) has about the physical properties given in Table III.

TABLE III

| Property | Value |
|---|---|
| Non-Volatile % 45° C., for 45′ | 78-82 |
| M/F/Me approx.¹ | 1/3.8/2.8 |
| Monomer Content Approx.² | 58 |
| Viscosity mPa s 23° C. | 2500-7500 |
| Density lbs/gal (kg/M³) approx. | 9.3 (1120) |
| Flashpoint ° C. | 33 |

¹M/F/Me refers to the ratio of metholyated melamine to formaldehyde to melamine in the crosslinking agent.
²The crosslinking agent forms multimers in solution. This value is the approximate amount of HMMM monomer present in solution.

The LMC may optionally comprise a crosslinking agent accelerator (CAA). Such a compound may serve to reduce the reaction time of the crosslinking agent and accelerate the formation of a water-resistant LMC. In an embodiment, the CAA is any agent chemically compatible with the LMC and that is able to accelerate the reaction of the crosslinking agent and hydrophilic base material. In an embodiment, the CAA is a polymer, alternatively an anionic polymer, alternatively a carboxyl-containing polymer, alternatively a carboxylated styrene-butadiene latex or combinations thereof. In an embodiment, the LMC comprises from about 2% to about 4% CAA. Without limitation, a representative example of a suitable CAA is a carboxylated styrene-butadiene latex sold as ROVENE 4009 by Mallard Creek Polymers Inc. In an embodiment, the CAA (e.g., ROVENE 4009) has about the physical properties given in Table IV.

TABLE IV

| Properties | Value |
|---|---|
| % Solids | 54 |
| Viscosity (cps) ¹ | 300 |
| pH | 7.25 |
| Particle size (nm) | 200 |
| Tg (° C.) ² | −4 |
| Styrene/Butadiene ratio | 58/42 |

¹ cps = centipoises
² Tg is the glass transition temperature

The LMC may further comprise an effective amount of additives for improving or changing the properties thereof, including without limitation emulsifiers, plasticizers or combinations thereof. In an embodiment, the LMC contains a plasticizer, which may serve to increase the flexibility, durability and shelf life thereof. Alternatively, the LMC contains an emulsifier that may prevent separation of the formulation components. Suitable plasticizers and emulsifiers are known to one of ordinary skill in the art. In an embodiment, the LMC may contain a single compound that functions as both a plasticizer and an emulsifier. Without limitation, an example of a plasticizer that also functions as an emulsifier for use in the LMC is a nonionic/anionic wax emulsion sold as AQUABEAD 270E by Micro Powders Inc. In an embodiment, the plasticizer is present in amounts of from about 0.4% to about 1.8%, alternatively from about 0.4% to about 1.2%, alternatively from about 0.8% to about 1.2%, alternatively the plasticizer is present in an amount that is 20% of the starch content (w/v).

Other additives chemically compatible with the formulation may be introduced by one skilled in the art to vary the properties of the LMC as needed. By way of example, the LMC may be varied to contain without limitation antimicrobial agents or dyes if necessary to impart certain physical properties to the hydrophobic substrate.

In an embodiment, the LMC may comprise from about 4% to about 6% hydrophilic base material; from about 100 parts hydrophilic base material: 5 parts lipid to about 100 parts hydrophilic base material:20 parts lipid; from about 0.5% to about 2% adhesion promoter; from about 0.1% to about 0.25% surfactant; from about 1% to about 4% crosslinking agent; from about 2% to about 4% CAA and optionally an effective amount of any additional additives with the remainder of the LMC being an aqueous carrier fluid, such as water. In an embodiment, the LMC may have a total solids content from about 6% to about 18%, alternatively from about 6% to about 15%, alternatively from about 6% to about 10%. In an embodiment, the LMC has a viscosity from about 80 centipoise to about 300 centipoise (cp), alternatively from about 100 cp to about 250 cp, alternatively less than about 200 cp.

In an embodiment, for preparation of the LMC, the hydrophilic base material is heated prior to the addition of other reagents. In an embodiment, the hydrophilic base material is a starch that is provided as starch slurry. The starch slurry may be heated by any method suitable for heating and maintaining the temperature of the starch slurry. Without wishing to be limited by theory, heating the starch slurry may make the starch completely water-soluble by disrupting the starch granules and breaking the hydrogen bonding. The starch slurry may be heated by the process ofjet-cooking. Herein the process of “jet cooking” refers to using a heat transfer device to instantaneously heat a flowing liquid with a hot condensable vapor and hold the heated liquid at a prescribed temperature for a prescribed time. Processes for jet cooking starch slurry have been disclosed in U.S. Pat. Nos. 3,988,483, 4,232,046 and 6,709,763, each of which are incorporated by reference herein in their entirety. Examples of heat transfer devices suitable for use in jet cooking an aqueous starch slurry are the HYDROHEATER available from Hydrothermal, Inc, Attec and the AWEC 2400 mixingjet cooker available from Q-Jet DSI, Inc.

Suitable conditions for jet cooking a starch slurry are known to one skilled in the art. The starch slurry may be jet cooked at a temperature from about 130° C. to about 150° C. and a pressure from about 20 psig to about 50 psig with a pumping rate of from about 0.75 to about 2.0 liters per minute to yield a starch dispersion. The term starch dispersion herein is meant to include the formation of a water-soluble starch solution wherein the starch granules have been disrupted by the heating process. The resulting starch dispersion may then be mixed with the desired lipid and jet cooked a second time as previously described to yield a starch-lipid slurry. In an embodiment, the jet-cooked aqueous starch-lipid slurry is rapidly cooled by placing the slurry on ice wherein a gel may not form. In another embodiment, the jet-cooked aqueous starch-lipid slurry is cooled to room temperature and a starch-lipid gel forms. The starch-lipid gel may then be redispersed in solution by mechanical agitation such as stirring or shaking. In yet another embodiment, the jet-cooked aqueous starch-lipid slurry is removed from the heat source and allowed to cool to room temperature. The starch-liquid slurry when prepared as described may form stable solutions that do not phase-separate into water and lipid components even after prolonged standing.

After treating the starch-lipid slurry as described, an appropriate amount of heated starch-lipid slurry, adhesion promoter, surfactant, crosslinking agent, CAA, additives and water may be mixed together to prepare the LMC. As will be understood by one of ordinary skill in the art, depending on the nature of the lipid used the concentration of the amylose-containing starch may be adjusted to allow the LMC to remain sprayable. In such embodiments, the concentration of amylose-containing starch in the formulation may be from about 3% to about 4%. In some embodiments, the LMC may be transferred to a device for application of the coating to a substrate. Alternatively, a single device may be used to prepare the LMC and coat the substrate. The LMC may be sprayed onto a hydrophobic surface. Sprayers suitable for use in this application are known to one skilled in the art and include pneumatic sprayers or spray guns. Examples of suitable pneumatic sprayers include without limitation, the EGA Manual Touch-Up Gun available from DeVilbiss Corporation or the AJ-401-LH sprayer available from Jacto.

In an embodiment, the LMC, the apparatus for coating the hydrophobic substrate, the hydrophobic substrate itself or combinations thereof may be heated prior to and/or during application of the LMC to the substrate. For example, the pneumatic sprayer may be used to apply the LMC to a hydrophobic substrate in the presence of “hot air”. Herein hot air is defined as having an ambient temperature of greater than about 25° C. to less than about 60° C. The temperature of the air can be elevated through the use of a heating device such as a hot gun, heater, blower or other known device suitable for elevating the ambient air temperature. In an embodiment, the heating device is a hair dryer that may be set on the highest setting. The stream of atomized LMC released from the pneumatic sprayer may be heated prior to contacting the substrate by a heating device integrated or in league with the spray device. Alternatively, a heating device external to the spray device may heat the stream of atomized LMC. For example, an operator may simultaneously apply an LMC to a substrate while directing a stream of hot air towards the LMC as it is released from the pneumatic sprayer.

In an embodiment, the LMC may be heated following application of the LMC to the substrate. The coated substrate may be heated at any temperature and for any time period using any known heating device that is compatible with both the coating and the substrate and activates the crosslinking agent. Herein the term activating the crosslinking agent refers to facilitating the reaction of the crosslinking agent and hydrophilic base material. Alternatively, the coated substrate may be heated in an oven at a temperature of equal to or greater than about 80° C. for from about 12 to about 24 hours, alternatively from about 12 hours to greater than about 24 hours. In some embodiments, the heating of the LMC coated substrate is carried out under vacuum. Process conditions such as time, temperature, pressure and combinations thereof may be adjusted to achieve a desired level of crosslinking and resultant performance of the LMC. Such process conditions may also vary based on the LMC composition, for example based on the presence and amount of a CAA.

The LMC may form a monolayer adhesive coating on the substrate. Alternatively, the substrate may be coated repeatedly with the LMC to form a multilayer adhesive coating comprising from about 1 to about 24 layers. Hereafter, the term adhesive coating (AC) refers to an LMC comprising a starch as the hydrophilic base material, a lipid, an adhesion promoter, a surfactant and a crosslinking agent that has been applied to a substrate in one or more layers but has not been heated to activate the crosslinker. Hereafter, the term water-resistant adhesive coating (WRAC) refers to an LMC comprising a starch as the hydrophilic base material, a lipid, an adhesion promoter, a surfactant and a crosslinking agent that has been applied to a substrate in one or more layers and has been heated to activate the crosslinker. Herein a water-resistant coating refers to a coating whose adhesion after exposure to water for some time period is approximately equivalent to its adhesion prior to water exposure, where adhesion is determined using the following adhesion testing method.

The adhesion of dried coatings to PE surfaces was evaluated by a method patterned after ASTM D 3359-02. Modifications of the ASTM method were made to make it more suitable for rapid, qualitative testing of thin and flexible plastic films. A 2.3×2.6 cm strip of pressure-sensitive adhesive tape attached to a flat aluminum surface was pressed firmly onto the coated PE surface. Examples of suitable pressure-sensitive tape include without limitation PERMACEL 99 commercially available from K.R. Anderson Inc. The tape was then removed by rapidly pulling straight up at an angle of about 90° to the surface, and the surface was visually examined to estimate the amount of coating removed. Test results were classified as shown in Table V.

TABLE V
Classification of Adhesion Test Results

| Percent of Coating Removed | Adhesion Classification Value |
|---|---|
| 0 | 5 |
| Less than 5 | 4 |
| 5-15 | 3 |
| 15-35 | 2 |
| 35-65 | 1 |
| Greater than 65 | 0 |

Alternatively, a water-resistant (WR) coating is a coating, which passes the Rub Test. Herein the Rub test refers to a procedure wherein the putative WRAC is exposed to water for some period and then subjected to manual rubbing. The WRAC is considered to have passed the Rub Test and is therefore characterized as water resistant if it continues to adhere to the substrate surface after this process.

In some embodiments, the LMC comprises 100 parts hydrophilic base material and 20 parts lipid. For example, the LMC may comprise 100 parts starch and 20 parts soybean oil. In such embodiments, the resulting AC may be characterized by oily surfaces that are easily removed by techniques such as wiping manually. In an embodiment, a LMC comprises from about 100 parts hydrophilic base material: 5 parts lipid to about 100 parts hydrophilic base material: 10 parts lipid. Such LMCs may be used to coat an appropriate substrate and heat treated as described to form a WRAC that is resistant to removal by manual wiping.

The LMC containing a crosslinking agent may be used to coat a suitable substrate thus providing a water-resistant hydrophilic layer to a surface. Suitable substrates for the LMC include but are not limited to hydrophobic surfaces, alternatively polymeric surfaces, alternatively polyolefin surfaces. The substrate may comprise a homopolymer, copolymer, or blends thereof. Examples of suitable material surfaces that may serve as substrates for the LMC include without limitation polyethylene terepthalate; polyethylenes such as high-density polyethylene, low-density polyethylene, linear low-density polyethylene; polypropylene; polyvinyl chloride; polystyrene and combinations thereof.

Polymer resins having the previously described properties may be formed into articles of manufacture or end use articles using techniques known in the art such as extrusion, blow molding, injection molding, fiber spinning, thermoforming, and casting. For example, a polymer resin may be extruded into a sheet, which is then thermoformed into an end use article such as a container, a cup, a tray, a pallet, a toy, or a component of another product. Examples of other end use articles into which the polymer resins may be formed include pipes, films, bottles, fibers, and so forth. In an embodiment, the substrate is an article of packaging of a consumer product. Additional end use articles would be apparent to those skilled in the art. The surface of such articles may serve as substrates for the LMC.

In an embodiment, the LMC produces an AC or WRAC capable of adhering to a hydrophobic substrate with an adhesion strength of from about 0 to about 5, alternatively from about 3 to about 5 as determined in accordance with adhesion testing method previously described.

In an embodiment, the AC formed upon application of the LMC to the substrate has an adhesion that is increased by heating the LMC and substrate to activate the crosslinking agent and form a WRAC. For example, the AC prior to heating may have an adhesion of about 0 to about 2; however, following heating and the formation of a crosslinked material, the WRAC may have an adhesion of from about 4 to about 5. In an embodiment, the adhesion of the WRAC is greater than that of the AC having an identical composition. In an embodiment, the WRAC adheres sufficiently to the substrate surface to resist separation from the surface of the substrate when the surface is manually and/or mechanically bent or flexed. In an embodiment, the WRAC adheres sufficiently to the substrate surface to resist separation from the substrate surface when the WRAC is manually rubbed, soaked in water or combinations thereof.

The WRAC may form a uniform hydrophilic coating on the substrate surface with a monolayer thickness of less than about 2 to less than about 5 microns. A WRAC formed by the methodology disclosed herein may have starch absorbed from about 0.01 to 0.2 mg per square cm of substrate, alternatively from about 0.035 to about 0.15 mg per square cm of substrate. A WRAC of this disclosure may have an opaque (turbid) appearance.

Substrates having LMCs of this disclosure may display desirable surface properties such as improved biocompatibility, improved compatibility with hydrophilic reagents, reduced build-up of electrostatic charge, reduced friction and improved absorption of both water-based and oil-based dyes, inks and fragrances.

### EXAMPLES

The invention having been generally described, the following examples are given as particular embodiments of the invention and to demonstrate the practice and advantages thereof. It is to be understood that the examples are given by way of illustration and are not intended to limit the specification or the claims in any manner.

Starch slurries were prepared by jet cooking 150 g of waxy cornstarch in 1000 ml of water at 140° C. and 40 psig at a rate of 1 liter/minute in a Penick and Ford Laboratory Model Steam Jet Cooker. To this starch dispersion was added a lipid and the sample cooked for a second time under the previously described conditions. For each of the tables in the examples, the particular lipid and amount added is given and an LMC was prepared by mixing the starch-lipid slurry with the indicated amounts of other reagents in solution, as indicated by the percentage value in the first column adjacent to each reagent. Hereafter, the remainder of the formulation (i.e. the balance to total 100 grams) is water. The initial starch-lipid concentration is given in the first column in each of the tables with the final starch concentration given in parentheses in subsequent columns. All percentages in the examples are of final % w/v unless otherwise indicated.

In each example, the LMC was stirred for 30 minutes and the viscosity of the composition measured by a Brookfield Viscometer Model LV at 60 RPM. The LMC was then fed to a pneumatic sprayer (EGA Manual Touch-Up Gun), which was used to coat a 6″×6″ polyethylene surface to from an AC. During application of the coating, a hot air gun set on the highest setting was aimed at the plastic surface in order to facilitate the LMC drying upon contacting the plastic surface.

In all examples, % refers to the final % w/v calculated as described herein while in parentheses next to each reagent is given the initial % w/v. The extent of adhesion prior to crosslinking was determined in accordance with the adhesion testing method previously described. The ACs were crosslinked by heating at 80° C. for 24 hours to produce a water-resistant adhesive coating and the adhesion of the WRAC tested in accordance with the adhesion testing method previously described and are reported herein as WRAC/Adhesion. In all examples the ratio of starch to lipid is given as part starch: parts lipid.

### Example 1

Coatings comprising waxy starch and soybean oil were prepared and evaluated. In Table VI, the ratio of waxy starch to soybean oil was 100:5.

TABLE VI

| | A | | B | | C | |
|---|---|---|---|---|---|---|
| Expt. | gms | % | gms | % | gms | % |
| Starch -Oil (10.7%) | 74.8 | 8.0 | 74.8 | 8.0 | 74.8 | 8.0 |
| | | (7.6) | | (7.6) | | (7.6) |
| Aqua 270 E (40%) | 3.8 | 1.52 | 3.8 | 1.52 | 3.8 | 1.52 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 15.95 | — | | — | | — |
| Total | 100 | | 100 | | 100 | |

| | | | |
|---|---|---|---|
| Viscosity, cp | 75 | 75 | 75 |
| Sprays/samples | 8(2) | 8(3) | 8(3) |
| AC Adhesion | 2A | 2A | 1A-2A |
| WRAC/Adhesion | WR/5A | WR/5A | WR/5A |

In Table VII, the ratio of waxy starch to soybean oil was 100:10.

TABLE VII

| | A | | B | | C | |
|---|---|---|---|---|---|---|
| Expt. | gms | % | gms | Expt. | gms | % |
| Starch -Oil (11.7%) | 68.4 | 8.0 | 68.4 | 8.0 | 68.4 | 8.0 |
| | | (7.3) | | (7.3) | | (7.3) |
| Aqua 270 E (40%) | 3.65 | 1.46 | 3.65 | 1.46 | 3.65 | 1.46 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 22.5 | — | | — | | — |
| Total | 100 | | 100 | | 100 | |

| | | | |
|---|---|---|---|
| Viscosity, cp | 75 | 75 | 75 |
| Sprays/samples | 8(2) | 8(3) | 8(3) |
| AC Adhesion | 1A-2A | 1A-2A | 1A-2A |
| WRAC/Adhesion | WR/5A | WR/5A | WR/5A |

The results demonstrate the ability of a LMC comprising a waxy starch and soybean oil to form a WRAC with a high degree of adhesion.

### Example 2

Coatings comprising waxy starch and soy fatty acid were prepared and evaluated. In Table VIII, the ratio of waxy starch to soy fatty acid, designated S-210, was 100:5.

TABLE VIII

| | A | | B | | C | |
|---|---|---|---|---|---|---|
| Expt. | gms | % | gms | % | gms | % |
| Starch-S-210 (10.4%) | 60.6 | 6.3 | 60.6 | 6.3 | 60.6 | 6.3 |
| | | (6.0) | | (6.0) | | (6.0) |
| Aqua 270 E (40%) | 3.0 | 1.2 | 3.0 | 1.2 | 3.0 | 1.2 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 31.0 | — | | — | | — |
| Total | 100 | | 100 | | 100 | |

| | | | |
|---|---|---|---|
| Viscosity, cp | 65 | 65 | 60 |
| Sprays/samples | 8(3) | 8(3) | 8(3) |
| AC Adhesion | 2A | 2A | 2A |
| WRAC/Adhesion | partial/4A | WR/5A | WR/5A |

In Table IX, the ratio of waxy cornstarch to soy fatty acid was 100:10 while in Table X the ratio of waxy cornstarch to soy fatty acid was increased to 100:20.

TABLE IX

| | A | | B | | C | |
|---|---|---|---|---|---|---|
| Expt. | gms | % | gms | % | gms | % |
| Starch - S-210 (10.7%) | 31.7 | 6.6 | 61.7 | 6.6 | 61.7 | 6.6 |
| | | (6.0) | | (6.0) | | (6.0) |
| Aqua 270 E (40%) | 3.0 | 1.2 | 3.0 | 1.2 | 3.0 | 1.2 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 29.85 | — | | — | | — |
| Total | 100 | | 100 | | 100 | |

| | | | |
|---|---|---|---|
| Viscosity, cp | 65 | 65 | 65 |
| Sprays/samples | 8(3) | 8(3) | 8(3) |
| AC Adhesion | 1A-2A | 1A-2A | 1A-2A |
| WRAC/Adhesion | partial/3A | WR/4A | WR/4A |

TABLE X

| | A | | B | | C | |
|---|---|---|---|---|---|---|
| Expt. | gms | % | gms | % | gms | % |
| Starch -S-210 (12.3%) | 58.54 | 7.2 | 58.54 | 7.2 | 58.54 | 7.2 |
| | | (6.0) | | (6.0) | | (6.0) |
| Aqua 270 E (40%) | 3.0 | 1.2 | 3.0 | 1.2 | 3.0 | 1.2 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 33.0 | — | | — | | — |
| Total | 100 | | 100 | | 100 | |

| | | | |
|---|---|---|---|
| Viscosity, cp | 65 | 65 | 65 |
| Sprays/samples | 8(3) | 8(3) | 8(3) |
| AC Adhesion | 1A-2A | 1A-2A | 1A-2A |
| WRAC/Adhesion | partial/5A | WR/5A | WR/5A |

The results demonstrate the ability of a LMC comprising a waxy starch and soy fatty acid to form a WRAC with a high degree of adhesion.

### Example 3

Coatings comprising waxy starch and tallow fatty acid were prepared and evaluated. In Table XI, the ratio of waxy starch to tallow fatty acid, designated T-11, was 100:10 while in Table XII the ratio of waxy starch to tallow fatty acid was increased to 100:20.

TABLE XI

| | A | | B | | C | |
|---|---|---|---|---|---|---|
| Expt. | gms | % | gms | % | gms | % |
| Starch -T-11 (10.6%) | 67.9 | 7.2 | 67.9 | 7.2 | 67.9 | 7.2 |
| | | (6.0) | | (6.0) | | (6.0) |
| Aqua 270 E (40%) | 3.0 | 1.2 | 3.0 | 1.2 | 3.0 | 1.2 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 23.65 | — | | — | | — |
| Total | 100 | | 100 | | 100 | |

| | | | |
|---|---|---|---|
| Viscosity, cp | 80 | 75 | 65 |
| Sprays/samples | 8(3) | 8(3) | 8(3) |
| AC Adhesion | 1A | 1A | 1A |
| WRAC/Adhesion | partial/5A | WR/5A | WR/5A |

TABLE XII

| | A | | B | | C | |
|---|---|---|---|---|---|---|
| Expt. | gms | % | gms | % | gms | % |
| Starch -T-11 (12.2%) | 59 | 7.2 | 59 | 7.2 | 59 | 7.2 |
| | | (6.0) | | (6.0) | | (6.0) |
| Aqua 270 E (40%) | 3.0 | 1.2 | 3.0 | 1.2 | 3.0 | 1.2 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 35.25 | — | | — | | — |
| Total | 100 | | 100 | | 100 | |

| | | | |
|---|---|---|---|
| Viscosity, cp | 90 | 80 | 70 |
| Sprays/samples | 8(3) | 8(3) | 8(3) |
| AC Adhesion | 1A-2A | 1A-2A | 1A-2A |
| WRAC/Adhesion | partial/5A | WR/5A | WR/5A |

The results demonstrate the ability of a LMC comprising a waxy starch and tallow fatty acid to form a WRAC with a high degree of adhesion.

### Example 4

Coatings comprising an amylose containing starch and soybean oil were prepared and evaluated. In the following examples, the jet cooked starch-lipid slurry was divided into two fractions. One fraction was cooled on ice, 1^{st} Fraction, while one fraction was allowed to cool at ambient temperature, 2^{nd} Fraction. The fraction cooled at ambient temperature, 2^{nd} Fraction, formed a gel that could be redispersed by stirring or shaking while the fraction cooled on ice remained fluid. ACs were prepared from each of the described fractions by the addition of reagents in the amounts indicated and crosslinked via heating to form WRACs. The ratio of amylose containing starch to soybean oil was 100:5 using either the 1^{st} Fraction or 2^{nd} Fraction as the starch-lipid source, Tables XIIIa and XIIIb respectively. The ratio of amylose containing starch to soybean oil was increased to 100:10 using either the 1^{st} Fraction or 2^{nd} Fraction as the starch-lipid source, Tables XIVa and XIVb respectively.

TABLE XIIIa

| | A | | B | | C | |
|---|---|---|---|---|---|---|
| Expt. | gms | % | gms | % | gms | % |
| Starch -Oil (9.7%) | 43.3 | 4.2 | 43.3 | 4.2 | 43.3 | 4.2 |
| | | (4.0) | | (4.0) | | (4.0) |
| Aqua 270 E (40%) | 2.0 | 0.8 | 2.0 | 0.8 | 2.0 | 0.8 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 49.25 | — | | — | | — |
| Total | 100 | | 100 | | 100 | |

| | | | |
|---|---|---|---|
| Viscosity, cp | 125 | 120 | 105 |
| Sprays/samples | 8(3) | 8(3) | 8(3) |
| AC Adhesion | 1A | 1A | 1A |
| WRAC/Adhesion | WR/5A | WR/5A | WR/5A |

TABLE XIIIb

| | A | | B | | C | |
|---|---|---|---|---|---|---|
| Expt. | gms | % | gms | % | gms | % |
| Starch -Oil (9.7%) | 43.3 | 4.2 | 43.3 | 4.2 | 43.3 | 4.2 |
| | | (4.0) | | (4.0) | | (4.0) |
| Aqua 270 E (40%) | 2.0 | 0.8 | 2.0 | 0.8 | 2.0 | 0.8 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA(25%) | 1.0 | 0.25 | 1.0 | 0.25 | 1.0 | 0.25 |
| Water | 49.25 | — | | — | | — |
| Total | 100 | | 100 | | 100 | |

| | | | |
|---|---|---|---|
| Viscosity, cp | 190 | 180 | 160 |
| Sprays/samples | 8(3) | 8(3) | 8(3) |
| AC Adhesion | 1A | 1A | 1A |
| WRAC/Adhesion | WR/5A | WR/5A | WR/5A |

TABLE XIVa

| | A | | B | | C | |
|---|---|---|---|---|---|---|
| Expt. | gms | % | gms | % | gms | % |
| Starch -Oil (10.0%) | 44.0 | 4.4 | 44.0 | 4.4 | 44.0 | 4.4 |
| | | (4.0) | | (4.0) | | (4.0) |
| Aqua 270 E (40%) | 2.0 | 0.8 | 2.0 | 0.8 | 2.0 | 0.8 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 48.55 | — | | — | | — |
| Total | 100 | | 100 | | 100 | |

| | | | |
|---|---|---|---|
| Viscosity, cp | 90 | 90 | 80 |
| Sprays/samples | 8(3) | 8(3) | 8(3) |
| AC Adhesion | 1A | 1A | 1A |
| WRAC/Adhesion | WR/5A | WR/5A | WR/5A |

TABLE XIVb

| | A | | B | | C | |
|---|---|---|---|---|---|---|
| Expt. | gms | % | gms | % | gms | % |
| Starch -Oil (10.0%) | 44.0 | 4.4 | 44.0 | 4.4 | 44.0 | 4.4 |
| | | (4.0) | | (4.0) | | (4.0) |
| Aqua 270 E (40%) | 2.0 | 0.8 | 2.0 | 0.8 | 2.0 | 0.8 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 48.55 | — | | — | | — |
| Total | 100 | | 100 | | 100 | |

| | | | |
|---|---|---|---|
| Viscosity, cp | 130 | 130 | 120 |
| Sprays/samples | 8(2) | 8(2) | 8(2) |
| AC Adhesion | 1A | 1A | 1A |
| WRAC/Adhesion | WR/5A | WR/5A | WR/5A |

The results demonstrate the ability of a LMC comprising an amylose containing starch and soybean oil to form a WRAC with a high degree of adhesion. When prepared as described, either starch-lipid slurry cooled on ice or cooled at ambient temperature could be used to produce a water-resistance adhesive coating with similar adhesion properties.

### Example 5

Coatings comprising an amylose containing starch and a soy fatty acid, designated S-210, were prepared and evaluated. In the following examples, the jet cooked starch-lipid slurry was divided into two fractions. One fraction was cooled on ice, 1^{st} Fraction, while one fraction was allowed to cool at ambient temperature, 2^{nd} Fraction. The fraction cooled at ambient temperature, 2^{nd} Fraction, formed a gel that could be redispersed by stirring or shaking while the fraction cooled on ice remained fluid. ACs were prepared from each of the described fractions by the addition of reagents in the amounts indicated and crosslinked via heating to form WRACs. The ratio of amylose containing starch to soy fatty acid was 100:5 using either the 1^{st} Fraction or 2^{nd} Fraction as the starch-lipid source, Tables XVa and XVb respectively. The ratio of amylose containing starch to soy fatty acid was increased to 100:10 using either the 1^{st} Fraction or 2^{nd} Fraction as the starch-lipid source, Tables XVIa and XVIB respectively and finally to 100:20, Tables XVIIa and XVIIb respectively.

TABLE XVa

| | A | | B | | C | |
|---|---|---|---|---|---|---|
| Expt. | gms | % | gms | % | gms | % |
| Starch -S-210(9.2%) | 34.2 | 3.15 | 34.2 | 3.15 | 34.2 | 3.15 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 58.85 | — | | — | | — |
| Total | 100 | | 100 | | 100 | |

| | | | |
|---|---|---|---|
| Viscosity, cp | 105 | 80 | 50 |
| Sprays/samples | 8(3) | 8(3) | 8(3) |
| AC Adhesion | 4A | 4A | 2A |
| WRAC/Adhesion | partial/5A | WR/5A | WR/5A |

TABLE XVb

| | A | | B | | C | |
|---|---|---|---|---|---|---|
| Expt. | gms | % | gms | % | gms | % |
| Starch -S-210(9.2%) | 34.2 | 3.15 | 34.2 | 3.15 | 34.2 | 3.15 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 58.85 | — | | — | | — |
| Total | 100 | | 100 | | 100 | |

| | | | |
|---|---|---|---|
| Viscosity, cp | 105 | 80 | 50 |
| Sprays/samples | 8(3) | 8(3) | 8(3) |
| AC Adhesion | 4A | 4A | 2A |
| WRAC/Adhesion | partial/5A | WR/5A | WR/5A |

TABLE XVIa

| | A | | B | | C | |
|---|---|---|---|---|---|---|
| Expt. | gms | % | gms | % | gms | % |
| Starch -S-210(10.1%) | 32.7 | 3.3 | 32.7 | 3.3 | 32.7 | 3.3 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 58.85 | — | | — | | — |
| Total | 100 | | 100 | | 100 | |

| | | | |
|---|---|---|---|
| Viscosity, cp | 110 | 80 | 50 |
| Sprays/samples | 8(3) | 8(3) | 8(3) |
| AC Adhesion | 2A | 1A-2A | 1A |
| WRAC/Adhesion | partial/5A | WR/5A | WR/5A |

TABLE XVIb

| | A | | B | | C | |
|---|---|---|---|---|---|---|
| Expt. | gms | % | gms | % | gms | % |
| Starch -S-210(10.1%) | 32.7 | 3.3 | 32.7 | 3.3 | 32.7 | 3.3 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 58.85 | — | | — | | — |
| Total | 100 | | 100 | | 100 | |

| | | | |
|---|---|---|---|
| Viscosity, cp | 110 | 80 | 50 |
| Sprays/samples | 8(3) | 8(3) | 8(3) |
| AC Adhesion | 2A | 1A-2A | 1A |
| WRAC/Adhesion | partial/5A | WR/5A | WR/5A |

TABLE XVIIa

| | A | | B | | C | |
|---|---|---|---|---|---|---|
| Expt. | gms | % | gms | % | gms | % |
| Starch -S-210(11.22%) | 32.1 | 3.6 | 32.1 | 3.6 | 32.1 | 3.6 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 58.85 | — | | — | | — |
| Total | 100 | | 100 | | 100 | |

| | | | |
|---|---|---|---|
| Viscosity, cp | 110 | 80 | 50 |
| Sprays/samples | 8(3) | 8(3) | 8(3) |
| AC Adhesion | 1A-2A | 1A-2A | 1A-2A |
| WRAC/Adhesion | partial/5A | WR/5A | WR/5A |

TABLE XVIIb

| | A | | B | | C | |
|---|---|---|---|---|---|---|
| Expt. | gms | % | gms | % | gms | % |
| Starch -S-210(11.22%) | 32.1 | 3.6 | 32.1 | 3.6 | 32.1 | 3.6 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 58.85 | — | | — | | — |
| Total | 100 | | 100 | | 100 | |

| | | | |
|---|---|---|---|
| Viscosity, cp | 110 | 80 | 50 |
| Sprays/samples | 8(3) | 8(3) | 8(3) |
| AC Adhesion | 1A-2A | 1A-2A | 1A-2A |
| WRAC/Adhesion | partial/5A | WR/5A | WR/5A |

The results demonstrate the ability of a LMC comprising an amylose containing starch and soy fatty acid to form a WRAC with a high degree of adhesion. When prepared as described, either starch-lipid slurry cooled on ice or cooled at ambient temperature could be used to produce a water-resistance adhesive coating with similar adhesion properties.

### Example 6

Coatings comprising an amylose containing starch and a tallow fatty acid, designated T-11, were prepared and evaluated. In the following example, the jet cooked starch-lipid slurry was divided into two fractions. One fraction was cooled on ice, 1^{st} Fraction, while one fraction was allowed to cool at ambient temperature, 2^{nd} Fraction. The fraction cooled at ambient temperature, 2^{nd} Fraction, formed a gel that could be redispersed by stirring or shaking while the fraction cooled on ice remained fluid. ACs were prepared from each of the described fractions by the addition of reagents in the amounts indicated and crosslinked via heating to form WRACs. The ratio of amylose containing starch to tallow fatty acid was 100:10 using either the 1^{st} Fraction or 2^{nd} Fraction as the starch-lipid source, Tables XVIIIa and XVIIIb respectively. The ratio of amylose containing starch to tallow fatty acid was increased to 100:20 using either the 1^{st} Fraction or 2^{nd} Fraction as the starch-lipid source, Tables XIXa and XIXb respectively.

TABLE XVIIIa

| | A | | B | | C | |
|---|---|---|---|---|---|---|
| Expt. | gms | % | gms | % | gms | % |
| Starch -T-11 (8.8%) | 37.5 | 3.3 | 37.5 | 3.3 | 37.5 | 3.3 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 55.55 | — | | — | | — |
| Total | 100 | | 100 | | 100 | |

| | | | |
|---|---|---|---|
| Viscosity, cp | 115 | 85 | 55 |
| Sprays/samples | 8(3) | 8(3) | 8(3) |
| AC Adhesion | 1A | 1A | 1A |
| WRAC/Adhesion | partial/5A | WR/5A | WR/5A |

TABLE XVIIIb

| | A | | B | | C | |
|---|---|---|---|---|---|---|
| Expt. | gms | % | gms | % | gms | % |
| Starch -T-11 (8.8%) | 37.5 | 3.3 | 37.5 | 3.3 | 37.5 | 3.3 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 55.55 | — | | — | | — |
| Total | 100 | | 100 | | 100 | |

| | | | |
|---|---|---|---|
| Viscosity, cp | 115 | 85 | 55 |
| Sprays/samples | 8(3) | 8(3) | 8(3) |
| AC Adhesion | 1A | 1A | 1A |
| WRAC/Adhesion | partial/5A | WR/5A | WR/5A |

TABLE XIXa

| | A | | B | | C | |
|---|---|---|---|---|---|---|
| Expt. | gms | % | gms | % | gms | % |
| Starch -T-11 (9.3%) | 38.7 | 3.6 | 38.7 | 3.6 | 38.7 | 3.6 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 54.35 | — | | — | | — |
| Total | 100 | | 100 | | 100 | |

| | | | |
|---|---|---|---|
| Viscosity, cp | 115 | 85 | 55 |
| Sprays/samples | 8(3) | 8(3) | 8(3) |
| AC Adhesion | 1A | 1A | 1A |
| WRAC/Adhesion | partial/5A | WR/5A | WR/5A |

TABLE XIXb

| | A | | B | | C | |
|---|---|---|---|---|---|---|
| Expt. | gms | % | gms | % | gms | % |
| Starch -T-11 (9.3%) | 38.7 | 3.6 | 38.7 | 3.6 | 38.7 | 3.6 |
| | | (3.0) | | (3.0) | | (3.0) |
| Aqua 270 E (40%) | 1.5 | 0.6 | 1.5 | 0.6 | 1.5 | 0.6 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 54.35 | — | | — | | — |
| Total | 100 | | 100 | | 100 | |

| | | | |
|---|---|---|---|
| Viscosity, cp | 115 | 85 | 55 |
| Sprays/samples | 8(3) | 8(3) | 8(3) |
| AC Adhesion | 1A | 1A | 1A |
| WRAC/Adhesion | partial/5A | WR/5A | WR/5A |

The results demonstrate the ability of a LMC comprising an amylose containing starch and tallow fatty acid to form a WRAC with a high degree of adhesion. When prepared as described, either starch-lipid slurry cooled on ice or cooled at ambient temperature could be used to produce a water-resistance adhesive coating with similar adhesion properties.

### Example 7

Coatings comprising an amylose containing starch and a paraffin wax or oil as the lipid were prepared and evaluated. As indicated the lipid source was either a paraffin wax with a melting point range of 56° C. to 61° C. or a paraffin oil. In the following examples, the jet cooked starch-lipid slurry was divided into two fractions. One fraction was cooled on ice, 1^{st} Fraction, while one fraction was allowed to cool at ambient temperature, 2^{nd} Fraction. The fraction cooled at ambient temperature, 2^{nd} Fraction, formed a gel that could be redispersed by stirring or shaking while the fraction cooled on ice remained fluid. ACs were prepared from each of the described fractions by the addition of reagents in the amounts indicated and crosslinked via heating to form WRACs. The ratio of amylose containing starch to paraffin wax was 100:10 using either the 1^{st} Fraction or 2^{nd} Fraction as the starch-lipid source, Tables XXa and XXb respectively. The ratio of amylose containing starch to paraffin oil was 100:10 using either the 1^{st} Fraction or 2^{nd} Fraction as the starch-lipid source, Tables XXIa and XXIb respectively.

TABLE XXa

| | A | | B | | C | |
|---|---|---|---|---|---|---|
| Expt. | gms | % | gms | % | gms | % |
| Starch -paraffin | 42.7 | 4.4 | 42.7 | 4.4 | 42.7 | 4.4 |
| wax (10.3%) | | (4.0) | | (4.0) | | (4.0) |
| Aqua 270 E (40%) | 2.0 | 0.8 | 2.0 | 0.8 | 2.0 | 0.8 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 49.85 | — | | — | | — |
| Total | 100 | | 100 | | 100 | |

| | | | |
|---|---|---|---|
| Viscosity, cp | 125 | 105 | 90 |
| Sprays/samples | 8(2) | 8(2) | 8(2) |
| AC Adhesion | 4A | 3A | 2A |
| WRAC/Adhesion | WR/5A | WR/5A | WR/5A |

TABLE XXb

| | A | | B | | C | |
|---|---|---|---|---|---|---|
| Expt. | gms | % | gms | % | gms | % |
| Starch -paraffin | 42.7 | 4.4 | 42.7 | 4.4 | 42.7 | 4.4 |
| wax (10.3%) | | (4.0) | | (4.0) | | (4.0) |
| Aqua 270 E (40%) | 2.0 | 0.8 | 2.0 | 0.8 | 2.0 | 0.8 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 49.85 | — | | — | | — |
| Total | 100 | | 100 | | 100 | |

| | | | |
|---|---|---|---|
| Viscosity, cp | 175 | 150 | 130 |
| Sprays/samples | 8(2) | 8(2) | 8(2) |
| AC Adhesion | 4A | 3A | 2A |
| WRAC/Adhesion | WR/5A | WR/5A | WR/5A |

TABLE XXIa

| | A | | B | | C | |
|---|---|---|---|---|---|---|
| Expt. | gms | % | gms | % | gms | % |
| Starch -paraffin | 44.4 | 4.4 | 44.4 | 4.4 | 44.4 | 4.4 |
| oil (9.9%) | | (4.0) | | (4.0) | | (4.0) |
| Aqua 270 E (40%) | 2.0 | 0.8 | 2.0 | 0.8 | 2.0 | 0.8 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 48.15 | — | | — | | — |
| Total | 100 | | 100 | | 100 | |

| | | | |
|---|---|---|---|
| Viscosity, cp | 135 | 115 | 95 |
| Sprays/samples | 8(2) | 8(2) | 8(2) |
| AC Adhesion | 4A | 3A | 2A |
| WRAC/Adhesion | WR/5A | WR/5A | WR/5A |

TABLE XXIb

| | A | | B | | C | |
|---|---|---|---|---|---|---|
| Expt. | gms | % | gms | % | gms | % |
| Starch -paraffin | 44.4 | 4.4 | 44.4 | 4.4 | 44.4 | 4.4 |
| oil (9.9%) | | (4.0) | | (4.0) | | (4.0) |
| Aqua 270 E (40%) | 2.0 | 0.8 | 2.0 | 0.8 | 2.0 | 0.8 |
| Epi-rez 3510(62%) | 3.2 | 2.0 | 3.2 | 2.0 | 3.2 | 2.0 |
| CYMEL 323 (80%) | 1.25 | 1.0 | 2.5 | 2.0 | 5.0 | 4.0 |
| ZONYL FSA (25%) | 1.0 | 0.25 | 1.0 | 0.25 | 1.0 | 0.25 |
| Water | 48.15 | — | | — | | — |
| Total | 100 | | 100 | | 100 | |

| | | | |
|---|---|---|---|
| Viscosity, cp | 175 | 155 | 135 |
| Sprays/samples | 8(2) | 8(2) | 8(2) |
| AC Adhesion | 4A | 3A | 2A |
| WRAC/Adhesion | WR/5A | WR/5A | WR/5A |

The results demonstrate the ability of a LMC comprising an amylose containing starch and either a paraffin wax or a paraffin oil to form a WRAC with a high degree of adhesion. When prepared as described, either starch-lipid slurry cooled on ice or cooled at ambient temperature could be used to produce a water-resistance adhesive coating with similar adhesion properties.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference herein is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A water-resistant hydrophilic coating comprising: a hydrophilic base material, a lipid, an adhesion promoter, a surfactant and a crosslinking agent.

2. The coating of claim 1 wherein the hydrophilic base material is a water-soluble polymer, a water-dispersible polymer, a water-reducible polymer or combinations thereof.

3. The coating of claim 2 wherein the water-soluble polymer is a starch, a starch mixture, a modified starch, a gum, polyvinyl pyrrolidone, modified cellulose, polyvinyl alcohol, polyacrylic acid, polyethyleneimine or combinations thereof.

4. The coating of claim 1 wherein the lipid is a soybean oil, soy fatty acid, tallow fatty acid, paraffin oil, a paraffin wax with a melting point of less than about 60° C. or combinations thereof.

5. The coating of claim 1 wherein the adhesion promoter is an epoxy resin.

6. The coating of claim 1 wherein the surfactant is a fluorosurfactant, sodium lauryl sulfate or combinations thereof.

7. The coating of claim 1 wherein the crosslinking agent is a methylated melamine formaldehyde resin, a methylated high imino melamine resin, a derivative of hexamethoxymethylmelamine or combinations thereof.

8. The coating of claim 1 further comprising a plasticizer, an emulsifer or both.

9. The coating of claim 8 wherein the plasticizer, emulsifer or both comprises a nonionic/anionic wax emulsion.

10. The coating of claim 1 further comprising a crosslinking agent accelerator.

11. The coating of claim 10 wherein the crosslinking agent accelerator is a polymer, an anionic polymer, a carboxyl-containing polymer, a carboxylated styrene-butadiene latex or combinations thereof.

12. The coating of claim 1 having an adhesion of from about 4 to about 5.

13. The coating of claim 1 wherein the crosslinking agent is activated by heating.

14. A method of preparing a water-resistant polymer surface comprising:
(a) preparing an adhesive coating comprising a hydrophilic base material, a lipid, an adhesion promoter, a surfactant and a crosslinking agent;
(b) applying said adhesive coating to a polymer surface; and
(c) heat treating said polymer surface under conditions sufficient to allow cross linking of the adhesive coating.

15. The method of claim 14 wherein the hydrophilic base material is a water-soluble polymer, a water-dispersible polymer, a water-reducible polymer or combinations thereof.

16. The method of claim 14 wherein the lipid is a soybean oil, soy fatty acid, tallow fatty acid, paraffin oil, a paraffin wax with a melting point of less than about 60° C. or combinations thereof.

17. The method of claim 14 wherein the adhesive coating is prepared by jet-cooking the hydrophilic base material, lipid or combinations thereof.

18. The method of claim 14 wherein the ratio of hydrophilic base material to lipid is from about 100:5 to about 100:20.

19. A method of increasing the absorption of water-based or oil-based dyes, inks, or fragrances in a hydrophilic coating comprising incorporating a lipid into the hydrophilic coating.

20. The method of claim 19 wherein the lipid is a soybean oil, soy fatty acid, tallow fatty acid, paraffin oil, a paraffin wax with a melting point of less than about 60° C. or combinations thereof.
